(19) United States
(12) Patent Application Publication
(10) Pub. No.: US 2007/0220108 A1
(43) Pub. Date: Sep. 20, 2007

(54) Mobile global virtual browser with heads-up display for browsing and interacting with the World Wide Web

(76) Inventor: Jerry M. Whitaker, Tampa, FL (US)

Correspondence Address: DENNIS L. COOK, ESQ.;THE LAW OFFICES OF DENNIS L COOK PLLC, 12718 DUPONT CIRCLE, TAMPA, FL, 33626, US

(21) Appl. No.: 11/716,280

(22) Filed: Mar. 9, 2007

Related U.S. Application Data
(60) Provisional application No. 60/782,987, filed on Mar. 15, 2006.

(51) Int. Cl. G06F 15/16

(52) U.S. Cl. 709/217

(57) ABSTRACT

This disclosure describes a new method to browse and interact with the World Wide Web and other users while mobile comprising the following components: 1) a mobile communications device including but not limited to Blackberries, personal data assistants, or smartphones; 2) special glasses or viewing surface including but not limited to LCD (liquid crystal display) glasses, 3-dimensional goggles, or Organic LED (light emitting diode) panels; 3) a data input device including but not limited to a data glove, finger sensor, data input pen, or gesturing device; 4) a mobile communications device headset; and 5) a third generation or more powerful wireless carrier, Voice over IP provider, or a wireless LAN technology such as WiFi or, Wi-Max, or Bluetooth.

### CROSS-REFERENCE TO RELATED APPLICATION

The present application claims the benefit of previously filed co-pending Provisional Patent Application, Ser. No. 60/782,987.

### FIELD OF THE INVENTION

This invention addresses the need to supply a full interactive web browsing experience to mobile users. Specifically, this disclosure describes an interactive system and method that allows a mobile web user to browse, participate in online gaming, and in general interact with the World Wide Web and other users via a new user interface for a mobile device that utilizes a large virtual color screen.

### BACKGROUND OF THE INVENTION

Currently, mobile users must peer at a small LCD screen on mobile cellular devices to see web content. The system and method of this disclosure enlarges the perceived screen and enables the user to experience the richness of an audio/visual web encounter. The disclosed system is a mobile, global service for playing online games and interacting with the World Wide Web (WWW) using next generation smartphones. The system can be viewed as an always on, always available, WWW service that gives smartphone users the ability to overcome current smartphone viewing limitations through the use of Liquid Crystal Display (LCD) glasses. Currently, cellular phone users must peer at a small LCD screen to access and see specially scaled back web pages that are severely restricted with respect to rich web content. Only basic text is used on these rudimentary web pages. The small size of the smartphone LCD screen is the primary reason for this crippling limitation of current technology. This will not change for the foreseeable future since manufacturers are reducing their hardware footprint, not increasing it. The disclosed system will allow users to see a virtual screen in front of them that is the size of a large television screen. The vastly increased perceived screen real estate allows for many possibilities including astounding game playing realism, deep immersion web interaction, streaming movies, sports, and video, video conferencing, viewing virtual digital art, and many others. The system requires a next generation smartphone, LCD glasses with stereophonic speakers, a finger pointing device, data input pen, or data glove, a cellular headset, and a third generation (3G) wireless carrier (or 4G), Voice Over IP (VOIP) provider, or a wireless local area network (LAN) technology such as WiFi (within the same building) or Wi-Max (within the same city) to play online games if a cellular signal is unavailable or unneeded.

Relevant prior art includes: World Intellectual Property Organization Pat. WO 2005/054782 A1—Mobile Geographic Information Display System; U.S. Publication 20020015008—Computer System and Headset-Mounted Display Device; U.S. Publication 20030092384—Piconetwork Radiotelephone Interfaces for Vehicles Including Wireless Pointing and Display Devices; U.S. Publication 20030160736—Portable Heads-up Display for Vehicle; U.S. Publication 20050096096—Wireless Communications Systems for Masks or Helmets; U.S. Pat. No. 4,636,866—Personal Liquid Crystal Image Display; U.S. Pat. No. 5,509,048—Radio Transceiver with Interface Apparatus Which Visually Displays Information and Method Therefor; U.S. Pat. No. 5,556,224—Radio Frequency Communication Device Including a Mirrored Surface; U.S. Pat. No. 5,969,698—Manually Controllable Cursor and Control Panel in a Virtual Image; U.S. Pat. No. 5,977,950—Manually Controllable Cursor in a Virtual Image; U.S. Pat. No. 6,073,033—Portable Telephone with Integrated Heads-up Display and Data Terminal Functions; U.S. Pat. No. 6,091,376—Mobile Telephone Equipment with Head-up Display; U.S. Pat. No. 6,091,546—Eyeglass Interface System; U.S. Pat. No. 6,697,721—Safety Devices for Use in Motor Vehicles; U.S. Pat. No. 6,747,611—Compact Optical System and Packaging for Head Mounted Display; and, U.S. Pat. No. 6,941,248—System for Operating and Observing Making Use of Mobile Equipment. None of this prior art discloses the unique combination of this system that allows for mobile users to enjoy a full web experience.

### BRIEF SUMMARY OF THE INVENTION

This invention is a new system and method to browse and interact with the World Wide Web and other users while mobile comprising the following components: 1) a mobile communications device including but not limited to Blackberries, personal data assistants, tablet PCs, or smartphones; 2) special glasses or viewing surface including but not limited to LCD (liquid crystal display) glasses, 3-dimensional goggles, or Organic LED (light emitting diode) panels; 3) a data input device including but not limited to a data glove, data input pen, finger sensor, or gesturing device; 4) a mobile communications device headset; and 5) a third generation or more powerful wireless carrier or Voice over IP provider, and/or a wireless local area network (LAN) technology such as WiFi (within the same building) or Wi-Max (within the same city) to play online games if a cellular signal is unavailable or unneeded.

Currently, mobile users must peer at a small LCD screen on mobile cellular devices to see web content. The system and method of this invention enlarges the perceived screen and enables the user to experience the richness of an audio/visual web encounter. Also, current users must fumble with an uncomfortably small keypad to dial, text message, navigate menus, and enter data. The system and method of this invention gives the user an entirely new interface.

It is an object of this invention to provide a system and method to access the World Wide Web while mobile, and view and interact with the web or other users via a large virtual color screen and stereophonic sound.

It is a further object of this invention to allow the user to enjoy the audio-visual richness of the World Wide Web without the limitation of the small mobile device LCD screen.

It is a further object of this invention to provide a hand command language such as American Sign Language or other custom designed hand signal languages to be used for interacting and controlling the system.

It is a further object of this invention to provide a voice-controlled command language to be used for interacting and controlling the system.

It is a further object of this invention to provide a method to enter, send, and receive text messages, or SMS messages that bypasses current small handset keypads by allowing phone dialing using hand and voice commands as well as receiving, rejecting calls, changing lines, conferencing, alerting when a voicemail or text or SMS message is received and who it is from, and including predefined messages that are easily brought up via hand commands or voice.

It is a further object of this invention to provide a screen overlay technology activated by voice or hand gesture which labels every possible virtual screen choice (hyperlink, cursor movement, selection, input, etc.) with an alphanumeric, symbol, or color designator and enables the user to instantly select the choice by voice, gesture, or eye focus.

It is a further object of this invention to provide a system and method to view streaming movies, sports, and video while mobile on a large virtual color screen with stereophonic sound.

It is a further object of this invention to provide a system and method to play on-line, real-time multi-person games while mobile on a large virtual color screen with stereophonic sound.

It is a further object of this invention to provide a system and method to videoconference while mobile on a large virtual color screen with stereophonic sound and also boost the productivity of mobile workers by providing mobile users the ability to create and edit documents and spreadsheets while mobile without the need for a computer.

It is a further object of this invention to provide a system and method to simultaneously experience audio-visual virtual vacations with multiple, geographically separated persons while mobile on a large virtual color screen in possible three dimensional graphics with stereophonic sound and to book a virtual vacation by seeing a map onscreen, pointing to it to select, and booking a package.

It is a further object of this invention to provide a system and method to view and hear digital art from a repository while mobile via a large virtual color screen and stereophonic sound.

It is a further object of this invention to provide a system and method to construct and interact with three dimensional virtual worlds and socialization worlds while mobile via a large virtual color screen and stereophonic sound.

It is a further object of this invention to provide a system and method to allow the user to assemble and organize their virtual, digital life while mobile via a large virtual color screen and stereophonic sound where the people contacts can be pulled up in virtual screens and activated via voice, eye focus, or hand commands.

It is a further object of this invention to provide a system and method to view global positioning system data via a large virtual color screen and stereophonic sound that allows the user to see and hear fine detail data for restaurants, traffic reports, current position, navigation directions, etc. for a desired destination.

It is a further object of this invention to provide a system and method to take part in a social community network that is not geographically limited and interact in real-time with virtual web denizens through avatar representation or digital likeness and voice artifact via a large virtual color screen with stereophonic sound.

For a fuller understanding of the nature and objects of the invention, reference should be made to the following detailed description taken in connection with the accompanying drawings.

### DESCRIPTION OF THE DRAWINGS

For a fuller understanding of the nature and objects of the invention, reference should be made to the accompanying drawings, in which:

FIG. 1 shows a general system overview diagram with components and their inputs and outputs;

FIG. 2 shows a typical user with the first generation system that employs a controller being worn;

FIG. 3 shows a typical user with the preferred second generation system that replaces the controller with software that runs directly on the smartphone or mobile device.

### DETAILED DESCRIPTION OF THE INVENTION

The drawing reference numerals as shown in the figures is as follows:

10—smartphone or mobile device

12—controller (microprocessor-based)

14—phone/controller interface

16—heads-up display with stereophonic speakers

18—heads-up display/controller interface

20—headset

22—headset/controller interface

24—dataglove or pointing device

26—dataglove/controller interface

Important aspects of system are that it is mobile and does not need a computer to function (no laptop e.g.). Also the mobile device interface is a completely new user interface as opposed to the small LCD screen and archaic keypad of current mobile device interfaces and is analogous to Microsoft's disk operating system (DOS) compared with their graphical user interface called Windows. Further the system is built around off-the-shelf components that exist today but is integrated by hardware and software interfaces that can be implemented by those skilled in the art. Mobile users need relatively minimal extra equipment—the equipment required for visualization are sleek LCD glasses. To interact with the system, data gloves, a virtual mouse, or a data input pen can be used to do freeform text by using the input device in the air to form characters, numbers, etc. where the system parses and translates to text on the screen/document to allow browsing the web. A small headset, such as one with earbuds, is used for stereo sound. On-line gaming by geographically separated players can be achieved with real-time feedback, without the need for a bulky gaming console such as PS3 or Xbox 360. The optimum mobile device (smartphone specifically) is equipped with onboard RAM, Bluetooth, 8 GB HDD, USB ports, and integrated GPS capability. All components need to have their own power, or be powered by USB bus (or other) in order to maintain mobility. A wireless LAN capability for retrieving system updates, Internet, etc. WiFi would allow garners to interact within a building or the same room if the Internet connection was unavailable. A Wi-Max capability would allow garners in the same city to play online games without a cellular connection.

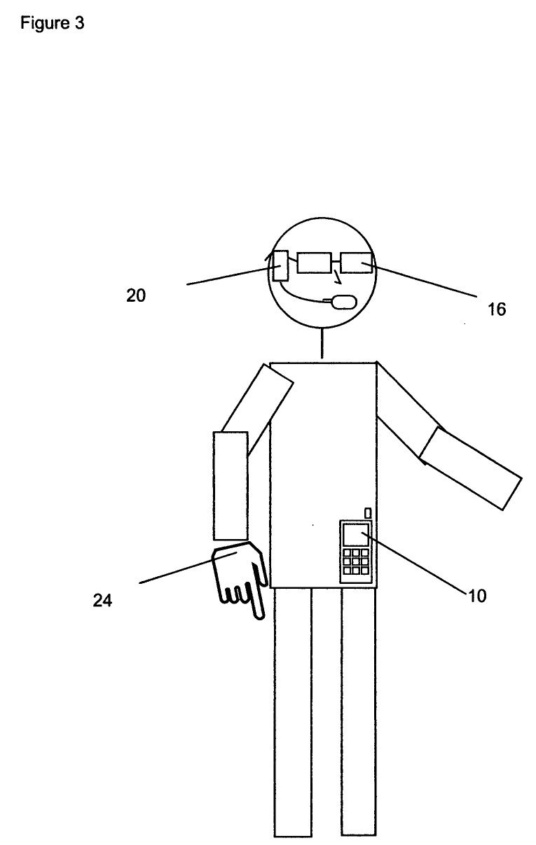

As shown in the preferred embodiment of FIG. 3 to use the system the user puts on the following components: 1) a mobile communications device including but not limited to Blackberries, personal data assistants, tablet PCs, or smartphones (10) which is connected to a third generation or more powerful wireless carrier or Voice over IP provider for wireless network access. Specifically in this instance, the Samsung SGH-i310 smartphone is attached to the person to allow “hands-free” operations through data glove(s) (24) but other mobile communications devices can be used as is well known by those skilled in the art; 2) a display device (16) incorporating special glasses or types of viewing surface known by those skilled in the art including but not limited to LCD (liquid crystal display) glasses, 3-dimensional goggles, or Organic LED (light emitting diode) panels. In this case, the i-glasses (16) are mounted on the head with LCD screens positioned in front of the user's eyes; 3) a data input device (24) including but not limited to a data glove, finger sensor, data input pen, or other gesturing device as is well known by those skilled in the art. In the shown preferred embodiment, the 5DT data glove(s) (24) are worn.; and, 4) a mobile communications device headset (20) compatible with the SGH-i310 smartphone (10) is put over the ear.

In operation the i-glasses video display (16) interfaces with the Samsung SGH-i310 smartphone (10) through the smartphone's (10) TV-OUT jack. The smartphone (10) device supports both NTSC and PAL output signals through a cable that terminates with output cables. These cables connect to the i-glasses (16) and may require adapters to go from composite video to the S-video input on the video glasses (16) as is well known by those skilled in the art.

The headset (20) connects wirelessly through Bluetooth network technology (22). Similarly, the data glove(s) (24) connects to the smartphone (10) via Bluetooth technology through the data glove “hub”.

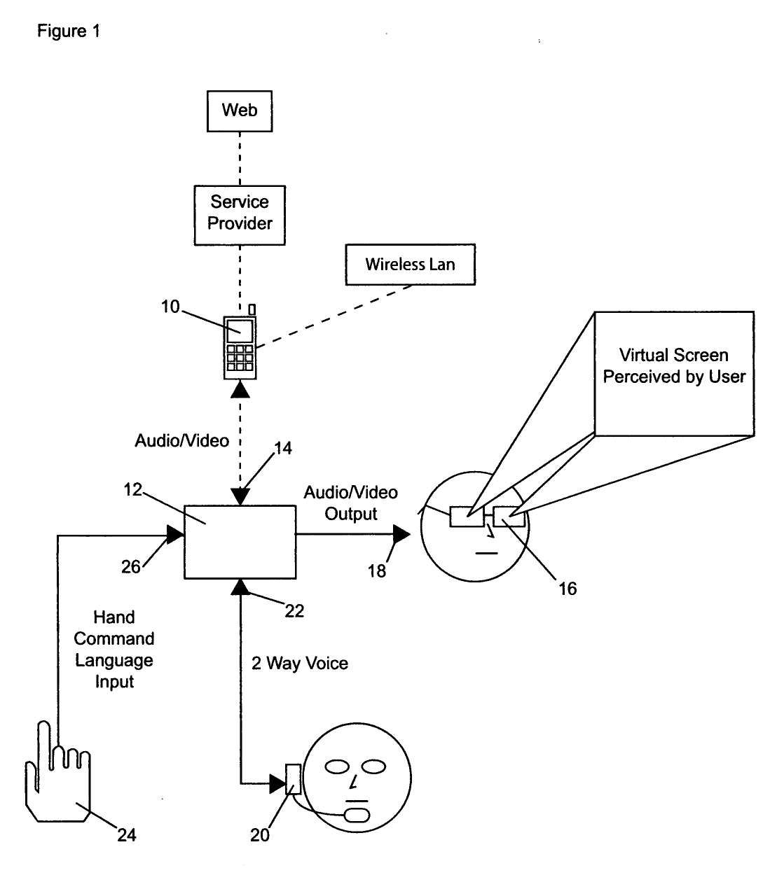

As further shown in operation in an alternative embodiment in FIG. 1 the SGH-i310 smartphone (10) is used to connect to the Internet via the service provider as is normally done. However, the image viewed by the user is a virtual color screen that “floats” in front of the individual and appears as a large screen of considerable size. For example, a 70″ screen is perceived by the user at 13 feet. This image is rendered on the LCD screens of the display (16), and through the effects of parallax and translation software well known by those skilled in the art running on the controller or the mobile device, the image appears as a large color screen. Special mirrors (e.g. half-silvered) may also be used and could provide eye tracking capabilities that would allow selections to be made by the user focusing on a particular point of the virtual screen. A cursor or arrow appears on the screen, just as a normal computer screen would be viewed. The TV OUT port from the SGH-i310 smartphone (10) drives the display device (16) and audio components. Current video standards are used to drive the display device (16) and current audio format standards are used to drive the audio components as are well known by those skilled in the art.

Movement in the browser is facilitated by the movement and positioning (gesture tracking) of the fingers or hand with the data input device (24). The motion and positioning is translated by the system to move the virtual cursor or pointer on the virtual screen (16). A software driver is used to move the cursor much as a computer mouse is positioned for a personal computer. Spatial positioning is relative and may employ body sensors. Initially, the data input device (24) uses relative positioning so that the hand may be positioned in three-dimensional space and the system will translate the virtual screen cursor position to be within the virtual screen real estate. Once the position has stabilized for a short period of time, subsequent movements of the hand track directly on the virtual screen. This gives the user flexibility to place the data input device (24) anywhere in three-space and start navigation. Some examples of hardware for gesture tracking are a magnetic ring mounted on the finger which is tracked by its magnetic field, a transceiver mounted on the finger, hand, or arm which transmits a know signal which is captured by the controller (12) or mobile device (10) and used for positioning and movement, or a data glove device (24) which transmits its position and gesturing data to the controller (12) or mobile device (10). Also, body sensors can be strategically located and used for gesturing. Finger articulation can also be facilitated through the use of a magnetic ring or data glove (24).

A screen overlay help feature is activated by hand command or speech command. Initially, the hand commands use a subset of American Sign Language but other hand command languages could be built from the ground-up as is well known by those skilled in the art. The system superimposes an intuitive labeling scheme with alphanumeric, color, or symbol data that visually cues the user to all available options or selections. The user visually inspects the screen (16) to determine which option they wish to activate or select. The user can point at the symbol to execute the action or may speak their choice, which will be acted upon by the speech recognition subsystem. By employing eye tracking techniques such as utilizing mirrors or lasers, the choice could also be made by visual focus of the user.

Exceptional bandwidth is required to carry all video and data components of the wireless signals as is well known by those skilled in the art. The system is designed to work with any bandwidth and will migrate in power as third generation wireless networks increase their bandwidth capacities or lead to fourth generation networks. Voice, video, and data needs to be carried wirelessly.

Mobile device computing power will depend primarily upon central processing unit (CPU) and memory constraints. A next generation ARM or mobile Pentium processor with 2 gigabytes of RAM may be used in the mobile device (10) to drive computations. Specialized operations (graphics, speech recognition, spatial positioning, video coding/decoding, gesture recognition) can be offloaded from the mobile device by coding and burning to an EPROM (Electrically Programmable Read Only Memory). This hardware solution is much faster than its software equivalent.

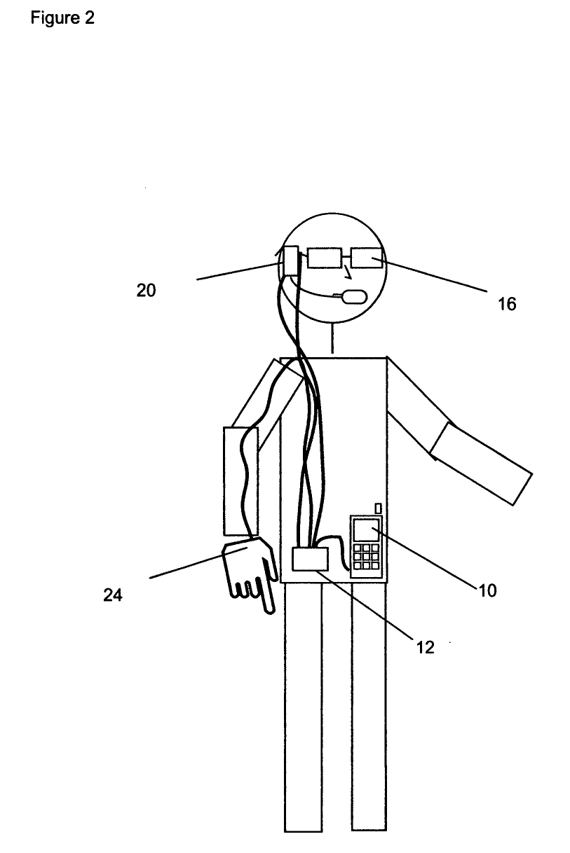

Alternative Embodiments are included as follows: 1) A hardware controller device (12) as shown in FIGS. 1 and 2 is used as a central control point to interface all of the devices through hardwired cables instead of running specialized software on the smartphone (10) itself; 2) the heads-up display (16) can be three dimensional goggles instead of LCD glasses; 3) the display (16) can be an organic light emitting diode (OLED) surface; 4) the display (16) can be advanced optic contact lenses; 5) the display (16) can be a holographic or interference-based image; 6) the display (16) can be the human retina which uses nanotechnology or other advanced biotechnology to transfer the digital video signal to the optic nerve; 7) the data input device (24) can be a virtual mouse, a pointing device, or body sensors instead of a data glove (24); 8) the system interconnections can be wired instead of wireless; 9) the hand command language input can be replaced or augmented by speech recognition technology; 10) the smartphone (10) device can be replaced by a tablet personal computer; 11) the mobile cellular device (10) can be replaced with satellite-based communication devices; and 12) gesture tracking could use lasers to detect eye movement and position

In the alternative embodiments operation shown in FIGS. 1 and 2 an interface cable (14) connects the mobile communications device (10) to the controller device (12). The controller (12) performs all operations to control the interfaces between the mobile communications device (10), the display device (16), the device headset (20), and the data input device (24). A second cable (audio/video) (18) connects the display device (16) to the controller (12). A third cable (data) (26) connects the data input device (24) with the controller (12). In this alternative embodiment of the system, a wireless technology (22) is used to connect the headset (20) with the controller device (12). All other connections will use wired connections. The preferred embodiment of the invention uses a wireless local network protocol such as Bluetooth, WiFi, or Wi-Max as discussed above and shown in FIG. 3.

System Components (SC) of the preferred embodiment include: 1) i-glasses Video head mounted display (16) (LCD glasses); 2) Samsung SGH-i310 Smartphone (10) or similar (Nokia N95, Samsung SCH-A990); 3) Standard Bluetooth headset (20) compatible with SGH-i310 device; 4) 5DT Data gloves Ultra Series (two required if virtual keyboard will be employed); and 5) 5DT Wireless Kit for data gloves but those skilled in the art could easily envision similar components that implement the system and method disclosed herein.

The following are the specifications for the preferred embodiment system components described above but those skilled in the art could easily envision other specifications that implement the system and method disclosed herein:
SC1—i-glasses Video head mounted display (16) (LCD glasses)
   I-O Display Systems, Menlo Park, Calif.
a) 1.44 million pixels per display
b) Virtual image size of 70″ at 13 feet
c) Color depth of 24 bits
d) PAL/NTSC composite or S-video input: Scaled to 800×600
e) Audio: full stereo
f) Weight: 7 ounces
g) Power: battery/charger bundle with Lithium Polymer battery—4 hours
SC2—Samsung SGH-i310 Smartphone (10) or similar
a) Windows Mobile 5 operating system
b) Intel Xscale PXA272 processor running at 416 Mhz
c) 128 MB ROM user-accessible
d) 64 MB RAM
e) Hard disk capacity of 8 GB
f) Interfaces:
   Expansion: SDIO, microSD, TransFlash
   Serial: RS-232 115200 bit/sec
   USB: USB 2.0
   Bluetooth: Bluetooth 2.0
g) TV OUT video output jack
h) Battery—Lithium-ion
SC4—5DT Data gloves (24) Ultra Series (two required if virtual keyboard is employed)
   5DT Irvine, Calif.
a) 8-bit flexure resolution
b) USB 1.1 interface
c) On-board processor
d) Bluetooth wireless connectivity up to 20 meters
e) Right and left-handed versions
f) Fiber optic-based
g) Power supplied through USB interface
h) Minimum 75 hertz sampling rate
SC5—5DT Wireless Kit for data gloves
   5DT Irvine, Calif.
a) Uses 2.4 Ghz Bluetooth spread-spectrum technology
b) Belt-worn kit with battery pack
c) One unit transmits data for both data gloves
d) Small form factor 4.33×3.27×1.65 inches
e) Lightweight 10.6 ounces

The system can be deployed as described in the following scenario. Ralph is in Tokyo on business. Cindy finally has a weekend off from surgery and would like to relax and see Ralph or speak with him. At the appointed hour, Cindy dons her LCD glasses, puts on a hand command glove, and connects the smartphone. She logs into her personal virtual universe. A virtual menu floats in front of her on a 36″ virtual screen. One of the selections is “The Magic of Italy”. She selects that option with a finger movement that the glove interprets, and a picture of Ralph appears. He says hello since he has already logged in—he was so excited about the virtual vacation that he couldn't wait. He sees a picture of Cindy as she logs on. They talk about their days for a few minutes and then decide to proceed on their virtual vacation. Remember, Ralph is physically in Tokyo and Cindy is in the United States.

A floating menu shows their possible destinations—Milan, Venice, Florence, Rome, Assisi, Sorrento, Pompeii, or Capri. They opt for Venice and a gondola tour at dusk. Both see the same actual professional video footage of the ride as they tour the canals. They can speak to each other real-time, of course, because of the cellular connection, and they can discuss what they see with each other. In essence, they feel together even though they are physically apart by thousands of miles.

Later Cindy wants to go to Vatican City and walk through the Sistine Chapel. Ralph agrees. With a few hand commands, a virtual option menu appears on the virtual screen and Cindy selects the Vatican City tour. Now both are virtually strolling through Vatican City and into the Sistine Chapel. They see the “Creation of Adam” fresco on the ceiling. Ralph pauses the view so that they can discuss it. After admiring it for five minutes, they change the angle via hand commands numerous times. They even increase magnification. Next stop, Rome and the Coliseum!

Even though physically separated, this couple enjoyed an Italian trip, and the pleasure of each other's company as they conversed with each other via the technology disclosed in this application that bridged the expanse of space between them to allow them to be together and share in the unique experience.

Since certain changes may be made in the above described interactive web browsing and online gaming system and method from the scope of the invention herein involved, it is intended that all matter contained in the description thereof or shown in the accompanying figures shall be interpreted as illustrative and not in a limiting sense.

What is claimed is:

1. A system for a user to browse, online game, and in general interact with the World Wide Web and other users while mobile comprising:
a mobile communications device;
a head mounted display in communication with said mobile communications device;
a data input device that uses hand gestures to generate input in communication with said mobile communications device;
a headset in communications with said mobile communications device; and,
a wireless carrier, Voice over IP provider, or a wireless LAN technology such as WiFi or, Wi-Max, or Bluetooth to connect said mobile communications device to the World Wide Web, or other users within the LAN.

2. The system of claim 1 wherein said mobile communication device is a Blackberry, personal data assistant, tablet PC, or smartphone.

3. The system of claim 1 wherein said head mounted display is a set of LCD (liquid crystal display) glasses, 3-dimensional goggles, or Organic LED (light emitting diode) panels.

4. The system of claim 1 wherein said data input device is a one or more data gloves, finger sensors, data input pens, or gesturing devices.

5. The system of claim 1 wherein said data input device uses eye movements along with or instead of hand gestures.

6. The system of claim 1 wherein said data input device uses voice commands along with or instead of hand gestures.

7. A system for a user to browse, online game, and in general interact with the World Wide Web and other users while mobile comprising:
a hardware controller device;
a mobile communications device in communication with said hardware controller device;
a head mounted display in communication with said hardware controller device;
a data input device that uses hand gestures to generate input in communication with said hardware controller device;
a headset in communications with said hardware controller device; and, a wireless carrier, Voice over IP provider, or a wireless LAN technology such as WiFi or, Wi-Max, or Bluetooth to connect said mobile communications device to the World Wide Web, or other users within the LAN.

8. The system of claim 7 wherein said mobile communication device is a Blackberry, personal data assistant, tablet PC, or smartphone.

9. The system of claim 7 wherein said head mounted display is a set of LCD (liquid crystal display) glasses, 3-dimensional goggles, or Organic LED (light emitting diode) panels.

10. The system of claim 7 wherein said data input device is a one or more data gloves, finger sensors, data input pens, or gesturing devices.

11. The system of claim 7 wherein said data input device uses eye movements along with or instead of hand gestures.

12. The system of claim 7 wherein said data input device uses voice commands along with or instead of hand gestures.
